(19) United States
(12) Patent Application Publication
(10) Pub. No.: US 2013/0332468 A1
(43) Pub. Date: Dec. 12, 2013

(54) User Reputation in Social Network and eCommerce Rating Systems

(71) Applicants: Manas S. Hardas, Fremont, CA (US); Lisa S. Purvis, Pleasanton, CA (US)

(72) Inventors: Manas S. Hardas, Fremont, CA (US); Lisa S. Purvis, Pleasanton, CA (US)

(73) Assignee: Spigit, Inc., Pleasanton, CA (US)

(21) Appl. No.: 13/491,560

(22) Filed: Jun. 7, 2012

(51) Int. Cl. G06F 17/30

(52) U.S. Cl. 707/748; 707/E17.005

(57) ABSTRACT

A rating system provides a mechanism whereby users can submit objects to be rated (ROs), and whereby users can submit ratings (ARs) regarding the ROs of other users. In a first novel aspect, each AR is multiplied by a weighting factor to determine a corresponding effective rating (ER). The weighting factor that is used to determine an ER from an AR is a function of the reputation RP_{T} of the user who submitted the AR. In a second novel aspect, the weighting factor is also a function of a crowd voting probability value P_{T}. In a third novel aspect, the weighting factor is also a function of the freshness RF of the AR. In a fourth novel aspect, a decay value D is employed in determining a user's reputation. ERs are used to determine a ranking of ROs. User reputation is used to determine a ranking of users.

### TECHNICAL FIELD

The present disclosure relates generally to network-based rating systems.

### BACKGROUND INFORMATION

Network-based rating systems are employed to rate objects. Examples of objects that can be rated include a quality of a service, a quality of a product, and a quality of an abstract notion such as an idea. A rating system in an ecommerce environment may rate quality of services and/or products. A rating system in a social networking environment may rate ideas and/or opinions. For example, a network-based idea rating system may be used to solicit ideas from users on how to solve a problem, to gather ratings from the users on how good the various submitted ideas are, and to output a ranked list of ideas where the ranking is based on feedback from users of the system. Ideas and ratings of those ideas may be collected from members of the general public, or may be collected from a select group of users such as employees of an organization or company. The quality of information output by the network-based rating system may depend on getting participation from the desired group of users, on facilitating the active engagement of the users, and on the reliability and truthfulness of the information the users put into the system.

### SUMMARY

A network-based rating system provides a mechanism whereby users can submit objects to be rated (ROs), and whereby users can submit ratings (ARs) regarding the ROs of other users. The ARs submitted are analyzed to determine a ranking of ROs, to determine a ranking of users, and to output of other information.

In a first novel aspect, each AR is multiplied by a weighting factor to determine a corresponding effective rating (ER). Rather than the ARs of ROs being averaged to determine a ranking of ROs, the ERs of ROs are averaged to determine a ranking of ROs.

The ERs regarding the ROs submitted by a particular user are used to determine a quantity called the “reputation” PR_{T} of the user. The reputation of a user is therefore dependent upon what other users thought about ROs submitted by the user. Such a reputation RP_{T} is maintained for each user of the system. The weighting factor that is used to determine an ER from an AR is a function of the reputation RP_{T} of the user who submitted the AR. If the user who submitted the AR had a higher reputation (RP_{T} is larger) then the AR of the user is weighted more heavily, whereas if the user who submitted the AR had a lower reputation (RP_{T} is smaller) then the AR of the user is weighted less heavily.

In a second novel aspect, the weighting factor used to determine an ER from an AR is also a function of a crowd voting probability value P_{T}. The crowd voting probability value P_{T} is a value that indicates the probability that the user who submitted the AR acts with the crowd in generating ARs. The crowd is the majority of a population that behaves in a similar fashion. The probability value P_{T} is determined by applying the Bayes theorem rule and taking into account the number of positive and negative votes. If the user who generated the AR it determined to have a higher probability of voting with the crowd (P_{T} is closer to 1) then the AR is weighted more heavily, whereas if the user who generated the AR is determined to have a lower probability of voting with the crowd (P_{T} is closer to 0) then the AR is weighted less heavily.

In a third novel aspect, the weighting factor used to determine an ER from an AR is a function of the freshness RF of the AR. If the AR is relatively old (RF is a large value) then the AR is weighed less heavily, whereas if the AR is relatively fresh (RF is a small value) then the AR is weighed more heavily.

In a fourth novel aspect, a decay value D is employed in determining a user's reputation. One component of the user's reputation is an average of ERs submitted in the current computing cycle. A second component of the user's reputation is a function of a previously determined reputation RP_{T-1} for the user from the previous computing cycle. The component of the user's reputation due to the prior reputation RP_{T-1} is discounted by the decay value D. If the user was relatively inactive and disengaged from the system then the decay value D is smaller (not equal to 1 but a little less, for example, D=0.998) and the impact of the user's earlier reputation RP_{T-1} is discounted more, whereas if the user is relatively active and engaged with the system then the decay value D is larger (for example, D=1) and the impact of the user's earlier reputation RP_{T-1} is discounted less.

As users submit ARs and ROs and use the system, the reputations of the users change. A ranking of users in order of the highest reputation to the lowest reputation is maintained and is displayed to users. Similarly, a ranking of ROs in order of the highest average of ERs for the RO to the lowest average of ERs for the RO is maintained and is displayed to users. At the end of a challenge period, the user with the highest ranked reputation may be determined and announced to be the winning user. At the end of the challenge period, the RO with the highest average of ERs may be determined to be the winning RO. The network-based rating system is usable to solicit and extract ROs from a group of users, and to determine a ranking of the ROs to find the RO that is likely the best RO.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is diagram of a network-based rating system 1 in accordance with one novel aspect.

FIG. 2 is a flowchart of a method involving an operation of the network-based rating system 1 of FIG. 1.

FIG. 3 is a table maintained by the network-based rating system in one computing cycle.

FIG. 4 sets forth an equation showing how an ER is determined from an AR.

FIG. 5 sets forth an equation showing how F1(RP_{T}) can be calculated given a value for RP_{T}.

FIG. 6 is a graphical depiction of the function F1 of the equation of FIG. 5.

FIG. 7 sets forth an equation showing how F2(RF) can be calculated given a value for RF.

FIG. 8 is a graphical depiction of the function F2 of the equation of FIG. 7.

FIG. 9 is a table that illustrates how probability values P_{T} are calculated for the example of ARs set forth in the table of FIG. 3.

FIG. 10 sets forth an equation showing how to calculate probability P_{T}.

FIG. 11 sets forth how to calculate the values P(B|A) and P(B|˜A) that are involved in determining the probability P_{T}.

FIG. 12 sets forth an equation showing how to calculate the value P(B) that is involved in determining the probability P_{T}.

FIG. 13 sets forth an equation showing how the reputation RP_{T} of a user is calculated.

FIG. 14 shows how the decay value D is determined.

FIG. 15 sets forth a numerical example of how a particular reputation in the example of FIG. 3 is calculated.

FIG. 16 is a table that shows how a ranking of users is determined.

FIG. 17 is a table that shows how a ranking of ROs is determined.

FIG. 18 is an illustration of a screen shot of what is displayed on the screen of the network appliance of the administrator ADMIN when the ADMIN is posting a challenge.

FIG. 19 is an illustration of a screen shot of how the challenge is presented to the users of the system.

FIG. 20 is an illustration of a page displayed on the screen of a user's network appliance after the user has entered an RO into the page but before the user has selecting the “SUBMIT” button.

FIG. 21 is an illustration of a page that displays ROs to the users of the system and solicits the users to submit ARs.

FIG. 22 is an illustration of a page that displays a ranking of ROs and a ranking of users.

FIG. 23 is an illustration of a page displayed on the screen of the network appliance of the user who submitted the highest ranked RO. The page informs the user that the user has won a reward for having submitted the best RO.

### DETAILED DESCRIPTION

Reference will now be made in detail to some embodiments of the invention, examples of which are illustrated in the accompanying drawings.

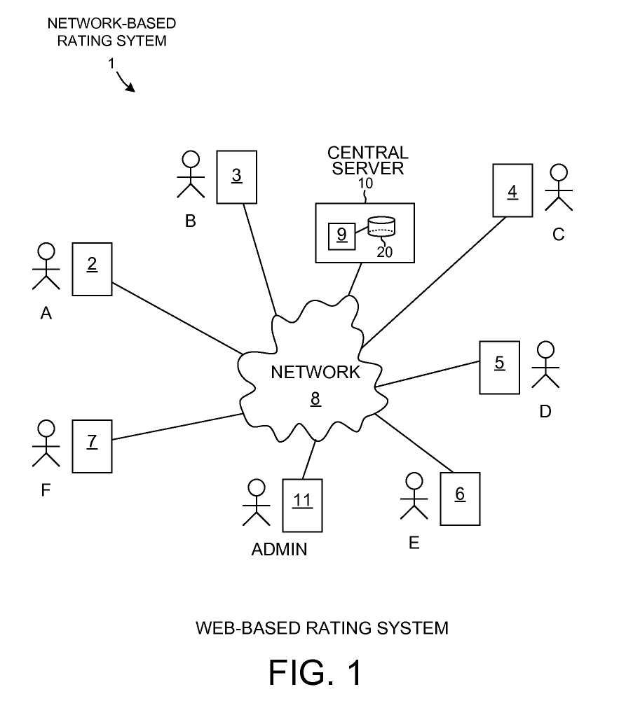

FIG. 1 is a diagram of a network-based rating system 1 in accordance with one novel aspect. Each of the users A-F uses an application (for example, a browser) executing on a networked appliance to communicate via network 8 with a rating system program 9 executing on a central server 10. Rating system program 9 accesses and maintains a database 20 of stored rating information. Blocks 2-7 represent networked appliances. The networked appliance of a user is typically a personal computer or cellular telephone or another suitable input/output device that is coupled to communicate with network 8. Each network appliance has a display that the user of the network appliance can use to view rating information. The network appliance also provides the user a mechanism such as a keyboard or touchpad or mouse for entering information into the rating system.

Network 8 is typically a plurality of networks and may include a local area network and/or the internet. In the specific example described here, an oil company suffered an oil well blowout and is looking for good ideas on how to stop the blowout in an effective and efficient manner. The users A-F are employees of the oil company. The network 8 is an intra-company private computer network maintained by the oil company for communication between employees when performing company business. The rating system program 9 is administered by the network administrator ADMIN of the company network 8. The administrator ADMIN interacts with network 8 and central server 9 via network appliance 11.

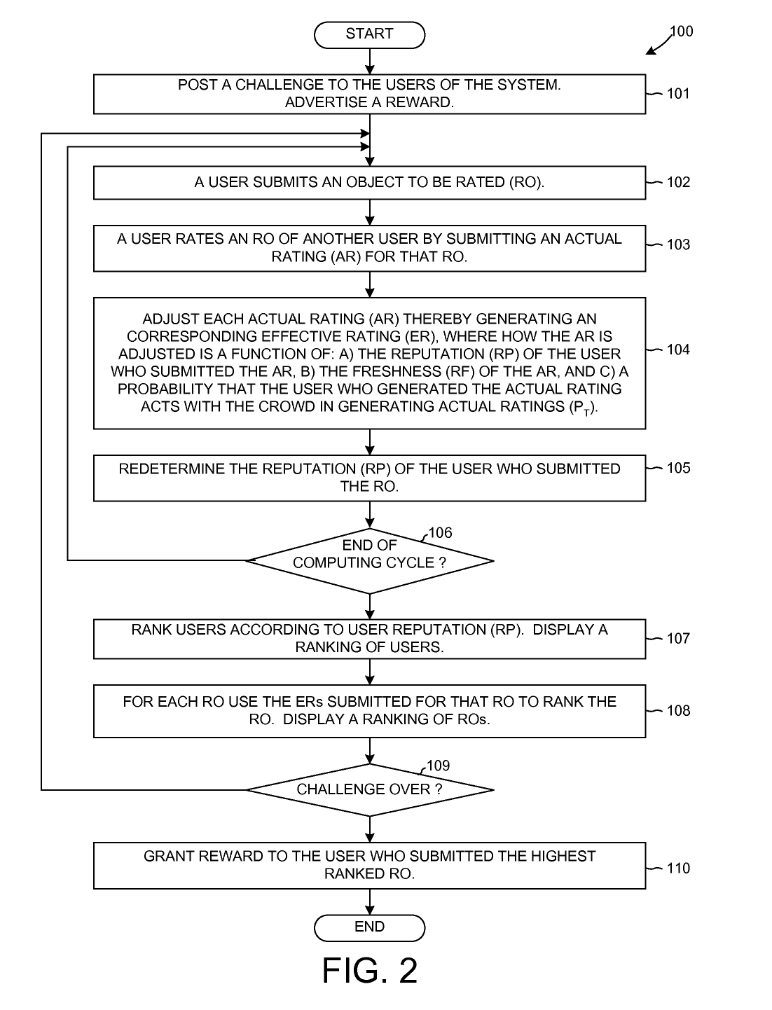

FIG. 2 is a flowchart of a method 100 involving an operation of the network-based rating system 1 of FIG. 1. The administrator ADMIN interacts with the rating system program 9, thereby causing a challenge to be posted (step 101) to the users A-F of the system. Through the system, each user is notified of the challenge via the user's networked appliance. In the present example, the challenge is titled “HOW CAN WE STOP THE OIL WELL BLOWOUT?”. To promote user interest and engagement with the system, the challenge involves a posted reward for the best idea submitted. In this case, the reward is a monetary reward. The web page that presents the challenge to a user also includes a text field. The web page solicits the user to type the user's idea into the text field.

In the method of FIG. 2, a user views this challenge-advertising web page and in response types the user's idea into the text box. The user's idea is an object to be rated, referred to here as a “rated object” or an “RO”. After typing the idea for how to stop the oil well blowout into the text box, the user selects a “SUBMIT” button on the page, thereby causing the RO to be submitted (step 102) to the rating system. Multiple such ROs are submitted by multiple users in this way. An individual user may submit more than one RO if desired. As ROs are submitted, a list of all the submitted ROs is presented to the users of the system. A user can read an idea (RO) submitted by another user, consider the merits of the idea, and then submit a rating for that idea. The rating is referred to here as an “actual rating” or an “AR”. In the present example, along with each idea displayed to the user, is a pair of buttons. The first button is denoted “−1”. The user can select this button to submit a negative rating or a “no” vote for the idea. The second button is denoted “+1”. The user can select this button to submit a positive rating or a “yes” vote for the idea. In the method of FIG. 2, the user selects the desired button, thereby causing the actual rating RA to be submitted (step 103) to the system. Before the user submits the AR, the user cannot see the number of +1 ARs and the number of −1 ARs the RO has received. This prohibits the user from being influenced by how others have voted on the RO. The system records the AR in association with the RO (the idea) to which the AR pertains. Multiple ARs are collected in this way for every RO from the various users of the system.

Rather that just using the raw ARs to determine a consensus of what the users think the best submitted idea is, each AR is multiplied by a rating factor to determine (step 104) an adjusted rating referred to as an “effective rating” or an “ER”. How the AR is adjusted to determine the associated ER is a function of: A) a previously determined reputation (RP) of the user who submitted the AR, B) the freshness (RF) of the AR, and C) a probability that the user who generated the AR acts with the crowd in generating ARs. The details of how an ER is determined from an AR is described in further detail below.

The reputation (RP) of a user is used as an indirect measure of how good ROs of the user tend to be. The user's reputation is dependent upon ERs derived from the ARs received from other users regarding the ROs submitted by the user. Accordingly, in the example of FIG. 2, after a new actual rating AR is received regarding the idea (the RO) of a user, the reputation of the user is redetermined (step 105). If the current computing cycle has not ended, then processing returns to step 102. New rated objects may be received into the system. Users may submit ARs on various ones of the ROs displayed to the users. Each time an AR is made, the reputation of the user who generated the RO is updated.

At the end of the computing cycle (step 106), processing proceeds to step 107. The system determines a ranking of the users (step 107) based on the reputations (RP) of the users at that time. The ranking of users is displayed to all the users A-F. In addition, for each RO the ERs for that RO are used to determine a rank (step 108) of the RO with respect to other ROs. The ranking of all ROs submitted is also displayed to the users A-F. In the illustrated specific embodiment, steps 107 and 108 occur at the end of each computing cycle. In other embodiments, the ranking of users and the ranking of ROs can be done on an ongoing constant basis. Computing cycles can be of any desired duration.

After the rankings of steps 107 and 108 have been performed, then the next computing cycle starts and processing returns to step 102 as indicated in FIG. 2. Operation of the rating system proceeds through steps 102 through 109, from computing cycle to computing cycle, with ROs being submitted and ARs on the ROs being collected. Each AR is converted into an ER, and the ERs are used to update the reputations of the users as appropriate. The ranking of users is displayed to all the users of the system in order to provide feedback to the users and to keep the users interested and engaged with the system. The public ranking of users incentivizes the users to keep using the system and provides an element of healthy competition.

After a certain amount of time, the system determines (step 109) that the challenge period is over. In the illustrated example, the highest ranked idea (highest ranked RO) is determined to be the winner of the challenge. The user who submitted that highest ranked RO is alerted by the system that the user has won the reward (step 110) for the best idea. The public nature of the reward and the public ranking of users and the public ranking of ideas is intended to foster excitement and competition and future interest in using the rating system.

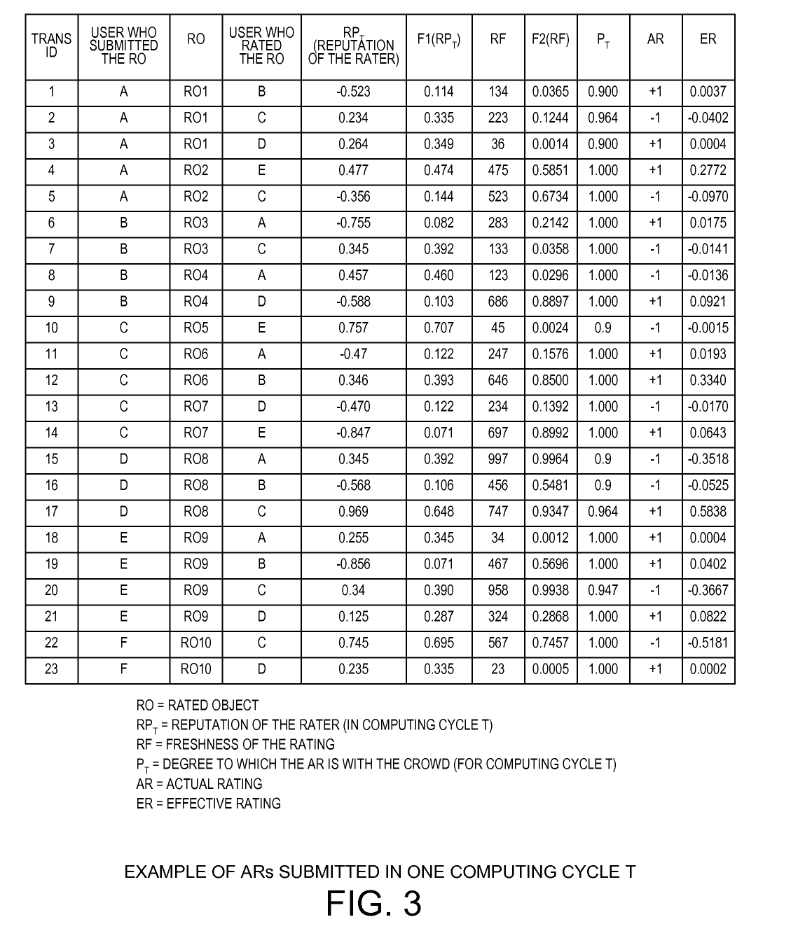

FIGS. 3-17 are diagrams that illustrate an operation of the web-based rating system 1 of FIG. 1 in further detail. FIG. 3 is a diagram of part of a database (in this case, a table) maintained by rating system program 9. The table includes one record (in this case a row) for each AR ever submitted during the challenge. The table includes rows for ARs submitted during the current computing cycle, and includes rows for ARs submitted in earlier computing cycles. For each such AR, the table records an indication of which user originally submitted the AR, an indication of the RO (the idea) for which the AR is a rating, an indication of the user who rated the RO, the reputation (RP_{T}) of the rater, and the effective rating (ER) determined from the AR. The quantities F1(RP_{T}), RF, F2(RF) and P_{T} are intermediary values used by the system to determine the ER from the AR as described in further detail below. There are many ways of recording the relational information of the table of FIG. 3 in a computer system. Indications of relationships between the information of a record need not necessarily by recorded as values in a row of a table. The representation of a table in FIG. 3 is just an example of one way that the relational information can be stored.

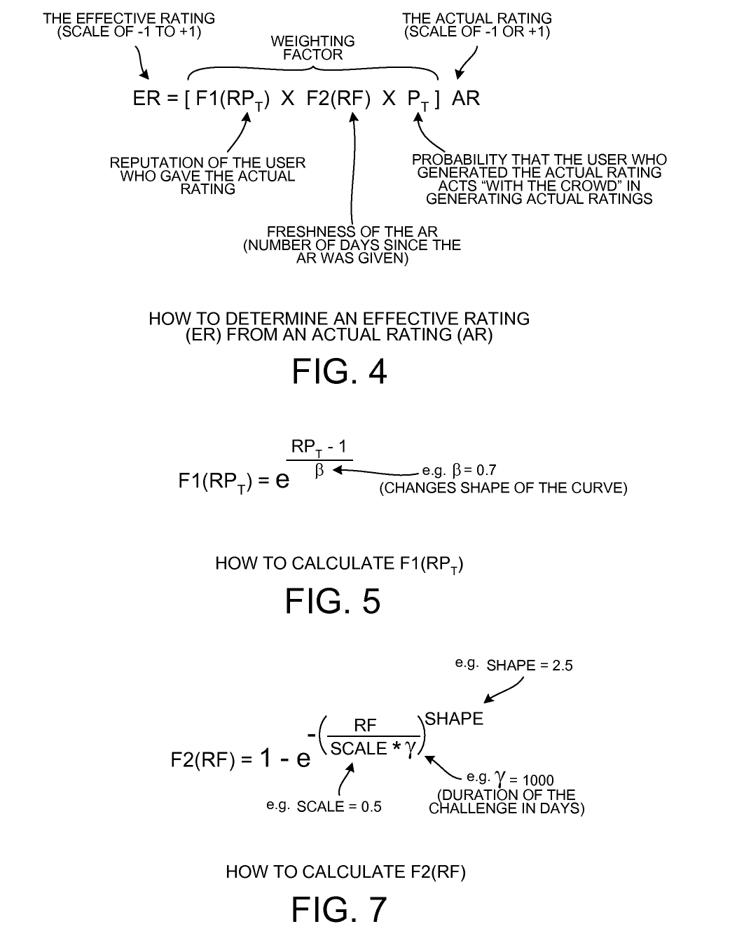

FIG. 4 shows how an effective rating (ER) is determined from an actual rating (AR). In this specific example, the AR is multiplied by a weighting factor. The weighting factor in turn is a function of the reputation of the user who submitted the AR, the freshness of the AR, and a probability that the user who generated the AR acts with the crowd in generating ARs. More specifically, the value RP_{T} is the reputation of the user who gave the AR. The “T” in the subscript of PR_{T} indicates that the reputation value is for the current computing cycle T. F1 is a function.

The value RF is the freshness of the AR since the AR was submitted. In the illustrated example, this RF value is a number of days since the AR was given. F2 is a function. The value P_{T} is a probability that the user who generated the AR acts “with the crowd” in generating ARs. How P_{T} is determined is described in further detail below. Functions F1 and F2 can be changed to tune operation of the system.

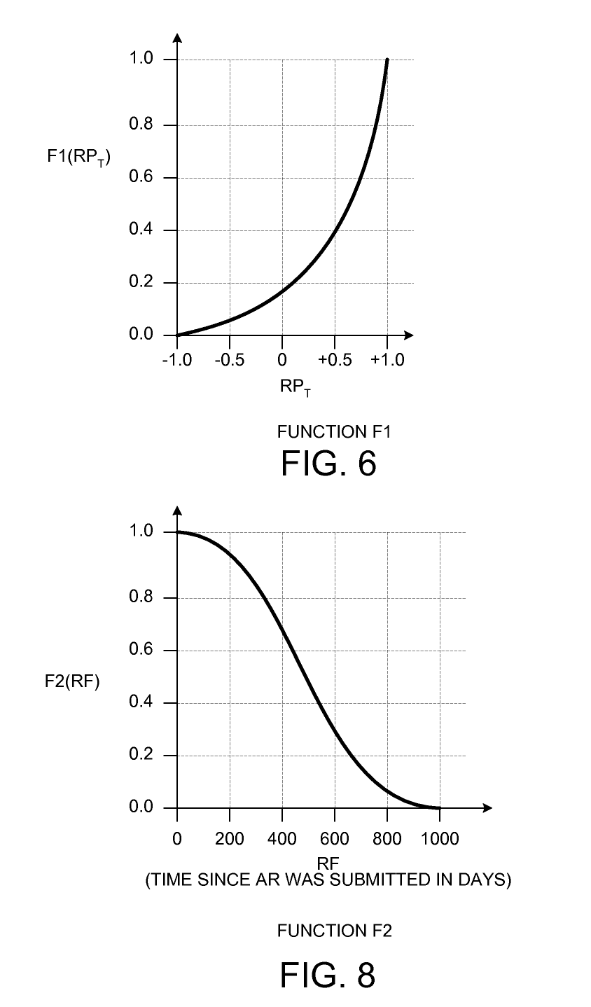

FIG. 5 shows how F1(RP_{T}) is calculated given an RP_{T} value. FIG. 6 is a chart that shows the F1(RP_{T}) value for a given RP_{T} value.

FIG. 7 shows how F2(RF) is calculated given an RF value. FIG. 8 is a chart that shows the F2(RF) value for a given RF value.

FIG. 9 is a table that illustrates how the quantity P_{T} is calculated. The quantity P_{T} is used, in accordance with the equation of FIG. 4, in the determination of an effective rating (ER) in the last column of the table of FIG. 3. For an RO being considered, the following values are calculated: UP, DOWN, NO ARS, P(A), P(˜A), P(B|A), P(B|˜A) and P(B). The value UP is the number of +1 actual ratings (ARs) received for the RO. The value DOWN is the number of −1 actual ratings (ARs) received for the RO. The value NO ARS is the number of times that a user was presented with the RO but the user failed to cast either a +1 vote or a −1 vote. The value P(A) is the probability in the prior computing cycle of that voter (the user who submitted the AR) voting with the crowd. The value P(˜A) is the probability in the prior computing cycle of that voter (the user who submitted the AR) not voting with the crowd. The value P(B|A) is general sentiment about RO given that the vote (the AR) is with the crowd. The value P(B|˜A) is the general sentiment about RO given that the vote (the AR) is against the crowd. The value P(B) is the general sentiment about the RO.

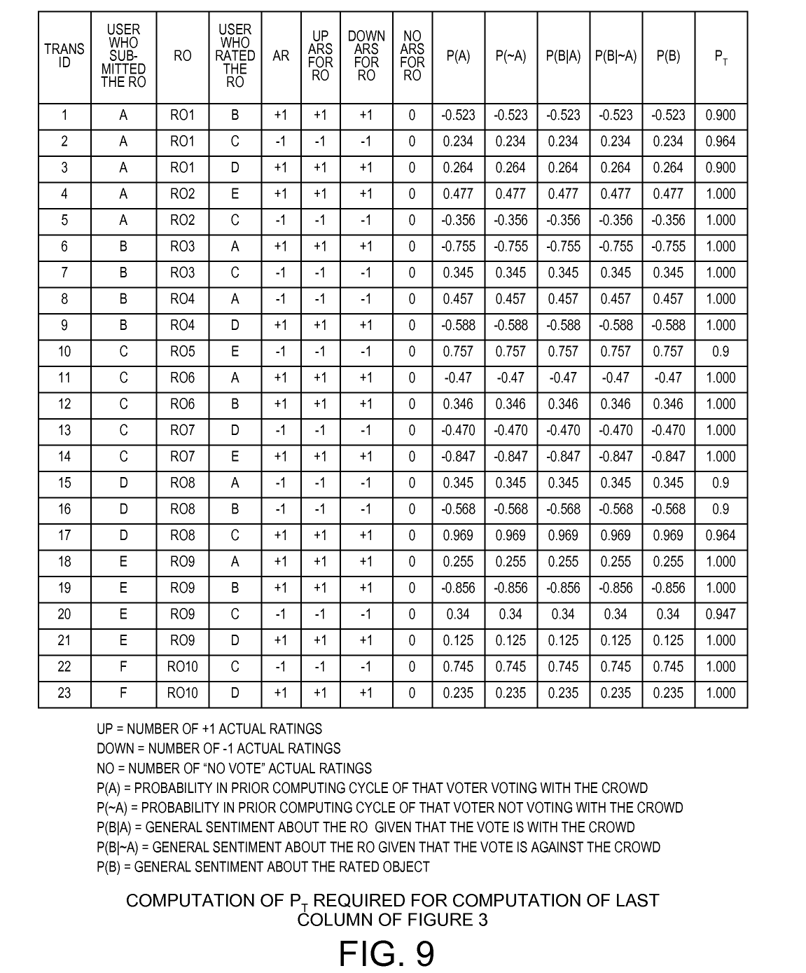

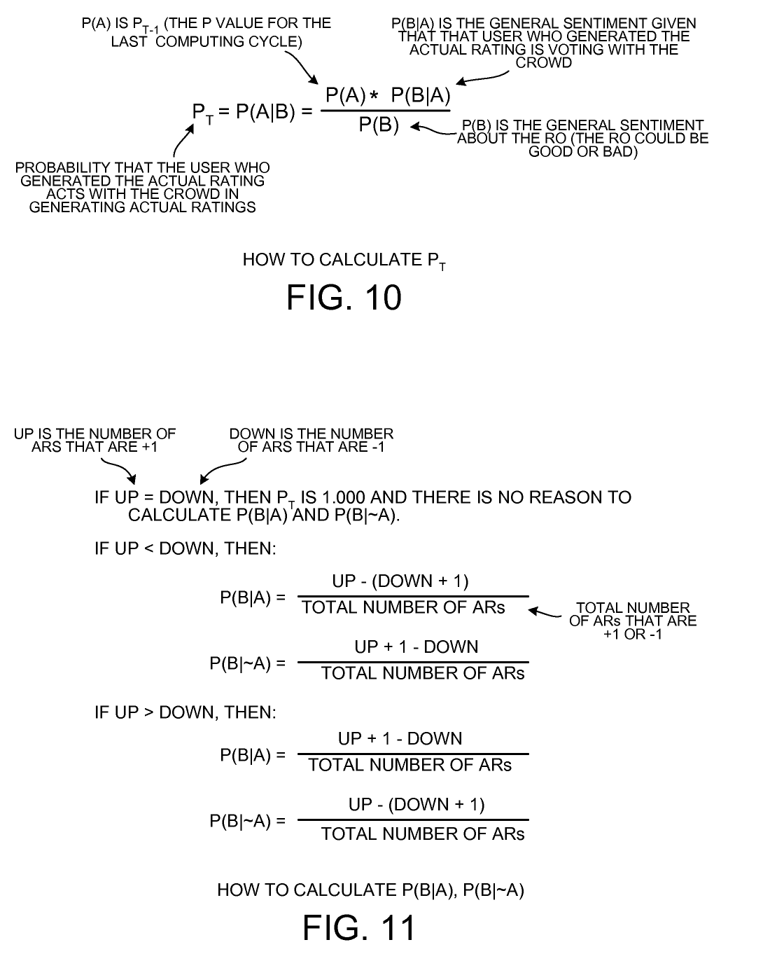

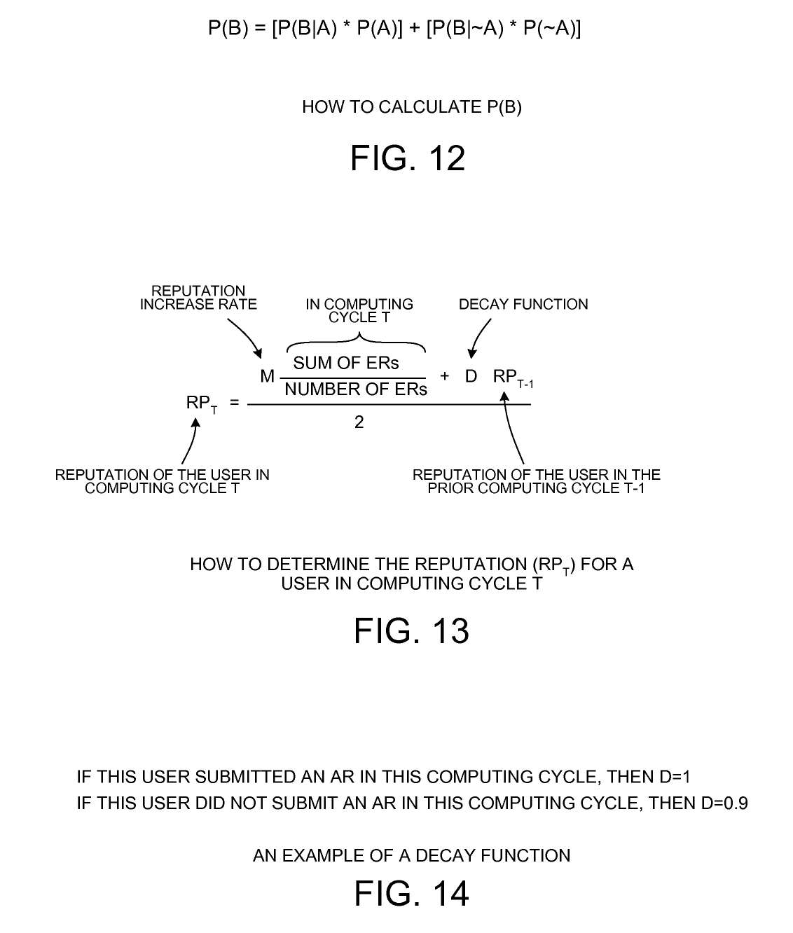

FIG. 10 shows how the value P_{T} is calculated using the values P(A), P(B|A) and P(B). FIG. 11 shows how the values P(B|A) and P(B|˜A) in the equation of FIG. 10 are determined using the quantities UP and DOWN. FIG. 12 shows how the value P(B) in the equation of FIG. 10 is determined using the values P(B|A), P(A), P(B|˜A) and P(˜A). As indicated in the equation of FIG. 4, the probability P_{T} that the user who generated the AR acts with the crowd is used in converting the AR into an effective rating ER.

FIG. 13 shows how the rater's reputation RP_{T} for the current computing cycle is calculated. The value RP_{T-1} is the rater's reputation from the prior computing cycle. In the equation of FIG. 13, the ER values that are summed, and whose sum is then divided by the number of ERs, are the ER values for ROs submitted by the user whose reputation is being determined. The ERs summed are only those ERs for ARs received in the current computing cycle. The decay function D in the equation of FIG. 13 is determined as set forth in FIG. 14. If the user whose reputation is being determined submitted an AR in the current computing cycle, then D=1. If, however, the user was inactive and did not submit an AR in the current computing cycle, then D=0.9. The decay value D of FIG. 14 is used to determine the RP_{T} of FIG. 13, and the reputation value RP_{T} is used to determine the effective rating ER as set forth in FIG. 4. The coefficient M is used to control the reputation increase/decrease rate.

FIG. 15 sets forth a numerical example of how the reputation RP_{T} is determined for user A at the end of the computing cycle, given the ARs set forth in the table of FIG. 3. As indicated in FIG. 3, there were five ARs submitted for ROs of user A in the computing cycle. The five ERs derived from these five ARs are averaged, and the average is used in the calculation of RP_{T} as set forth in FIG. 15. In the example of FIG. 15, for simplification purposes, it is assumed that the user A was active in the prior computing cycle. The decay value D is therefore 1.0. The reputation value RP_{T-1} for user A in the prior computing cycle was 0.05. In this way, the reputation RP_{T} of each user is recalculated each time another user votes on an RO submitted by the user.

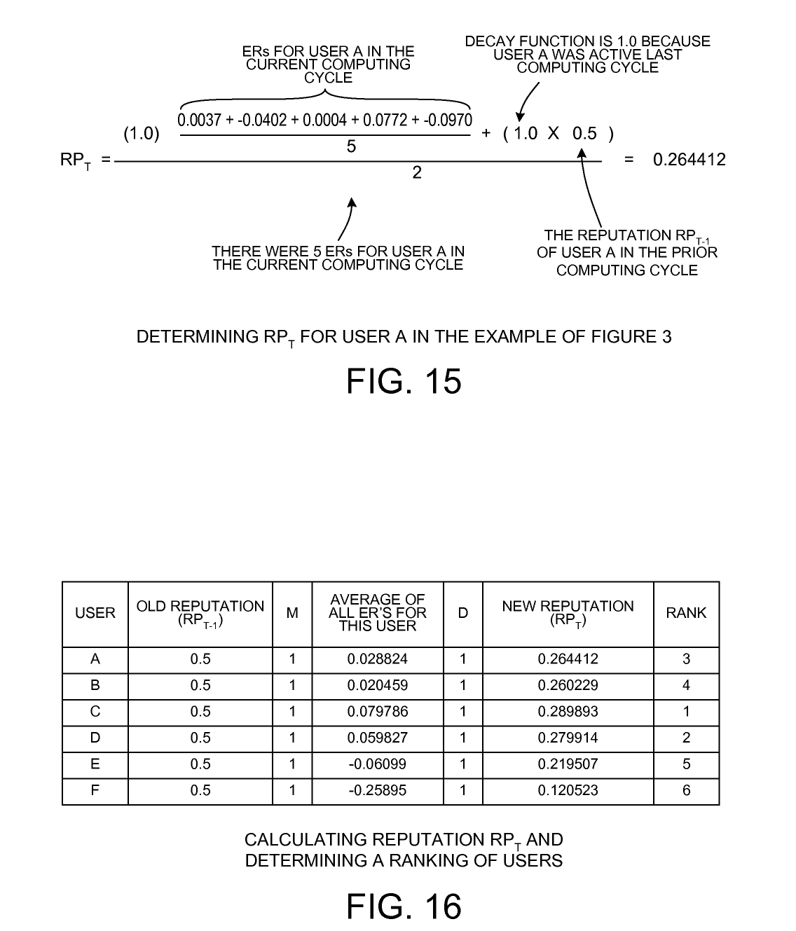

FIG. 16 is a table showing how the reputation values RP_{T} for the users A-F in the present example are calculated at the end of the computing cycle to which the table of FIG. 3 pertains. In this example, the prior reputations RP_{T-1} of all the users are assumed to be 0.5 and the reputation increase rate M is set to be 1.0. The decay value D for all users is 1.0 because all users in this example were active in the prior computing cycle. The resulting calculated reputation values RP_{T} are put in numerical order from largest to smallest in order to determine the ranking of users. As indicated above, this ranking of users is displayed to all the users A-F as they use the system. As the various users of the system submit ROs and submit ARs, their reputations and ranks change.

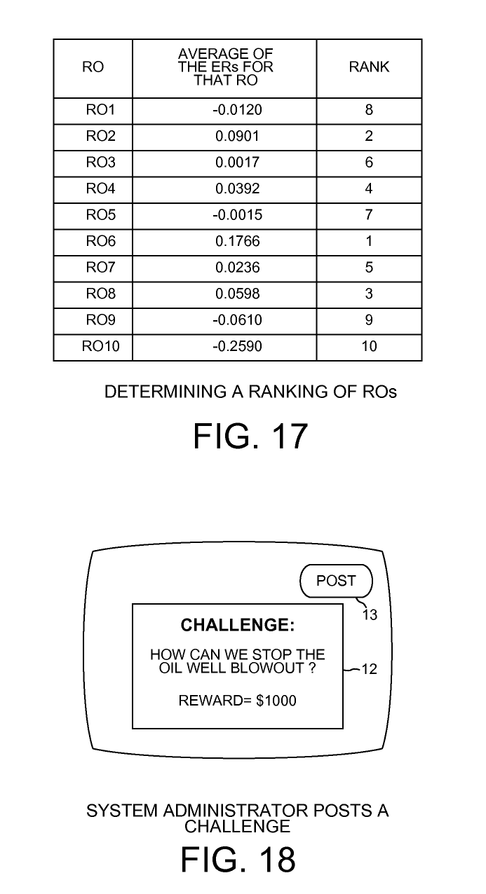

FIG. 17 is a table showing how the ROs are ranked in order to determine the ranking of ROs. For each RO submitted, all the ERs for that RO (whether the ERs were due to ARs submitted in the current computing cycle or whether the ERs were due to ARs submitted in prior computing cycles) are averaged. The middle column in the table of FIG. 17 sets forth these average ER values. The resulting averages are ranked in numerical order from largest to smallest to determine the ranking of ROs. The rightmost column of FIG. 17 sets forth the ranking of ROs. As indicated above, this ranking of ROs is displayed to all the users A-F as they use the system. As users submit ROs and submit ARs, the ranking of ROs changes. At the end of the challenge, the highest ranked RO is the winning RO and the user having the highest ranked reputation is the winning user. The user who submitted the winning RO may be different from the user that had the highest ranked reputation.

FIG. 18 is an illustration of a screen shot of what is displayed on the screen of the network appliance of the administrator ADMIN of the system. The ADMIN is being prompted to post a challenge. The ADMIN types a description of the challenge and the associated reward into text box 12 as illustrated, and then selects the “POST” button 13. This causes the challenge to be submitted to the system.

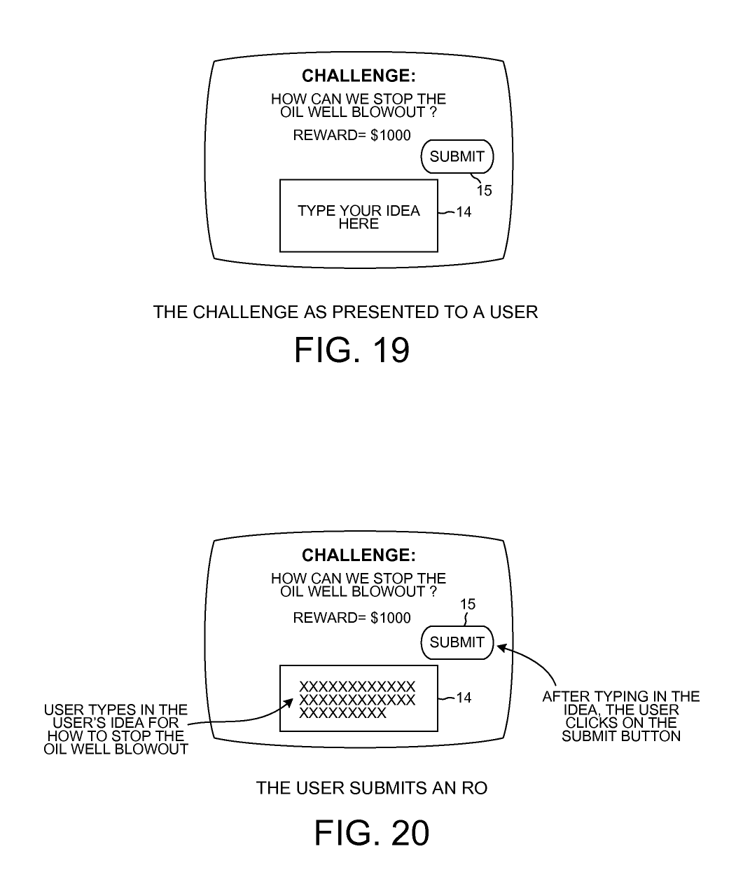

FIG. 19 is an illustration of a screen shot of what is then displayed to the users A-F of the system. The challenge is advertised to the users. The text box 14 presented prompts the user to type an RO into the text box 14. After the user has entered an RO, the user can then selected the “SUBMIT” button 15 to submit the RO to the system.

FIG. 20 is an illustration of a page displayed on the screen of a user's network appliance. The user has entered an RO (has typed in an idea for how to stop the oil well blowout) into the text box 14 before selecting the “SUBMIT” button 15.

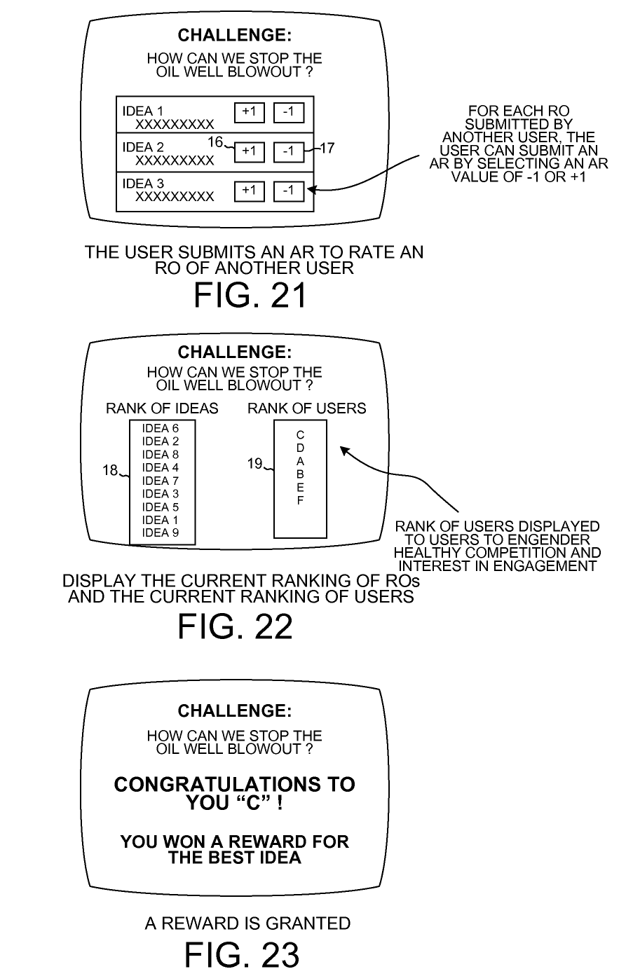

FIG. 21 is an illustration of a page displayed on the screen of the network appliance of each user of the system. The page shows each submitted RO as of the time of viewing. For each RO, the user is presented an associated “−1” selectable button and an associated “+1” selectable button. For example, if the user likes the RO listed as “IDEA 2”, then the user can select the “+1” button 16 to the right of the listed “IDEA 2”, whereas if the user does not like the RO listed as “IDEA 2” then the user can select the “−” button 17 to the right of the listed “IDEA 2”. Each user is informed of all of the submitted ROs using this page, and the user is prompted to vote (submit an AR) on each RO using this page.

FIG. 22 is an illustration of a page displayed on the screen of the network applicants of each user of the system. The page shows the current ranking of ROs 18 as well as the current ranking of users 19.

FIG. 23 is an illustration of a page displayed on the screen of the network appliance of the user who submitted the highest ranked RO. At the end of the challenge, the screen notifies user C that user C has won the challenge for submitting the best idea.

Disparate Quality of Ratings:

The opinions of, and therefore the ratings given by, some users tend to be more correct and useful that the opinions of other users. Due to this disparity, the actual ratings received from different users regarding the same RO should not all be considered with equal weight if it can be determined which raters tend to have better opinions. Also sometimes in social rating systems there are a few malicious users who may want to game the system. There are many factors that can be considered in determining how to weigh the ratings given by different users. In the present example, data is analyzed to determine a measure of the quality of ratings given in the past. An assumption is made that the ratings that other users gave to ROs submitted by a user have a relation to the quality of opinions or ratings that the user will likely give in the future. Accordingly, the weighting factor in the equation of FIG. 4 that is multiplied by an AR to generate an ER includes the factor F1(RP_{T}), where the RP_{T} is a function of the average of ERs given by others to ROs of the user. If other users rate ROs of the user relatively highly with positive ratings and only few negative ratings, then the average of ERs in the equation of FIG. 13 will be relatively large and the reputation RP_{T} of the user will be higher. ARs of the user will therefore be weighted relatively highly as compared to ARs given by other raters. If, however, other users rate ROs of the user relatively low with negative ratings only few positive ratings, then the average of ERs in the equation of FIG. 13 will be relatively low and the reputation RP_{T} of the user will be lower. ARs of the user will therefore be weighted relatively lightly as compared to ARs given by other raters.

The quality of submitted ratings has also been found to have a correlation to how long it has been since the actual rating was given. It is assumed that over time the relative quality of opinions and ratings tends to increase for example due to cumulative community consensus thinking. Accordingly, the weighting factor that is multiplied by the AR to generate an ER includes the factor F2(RF), where RF is the freshness of the AR in terms of the number of days since the AR was given. As shown by the graph of FIG. 8, if the time since the AR was given is low, then the F2(RF) is 1.0 or close to 1.0 and the weighting of the AR is not degraded due to age of the AR. If, however, the time since the AR was given is high, then the F2(RF) is low and the weighting of the AR is degraded due to the age of the AR.

Disengagement:

It has been recognized that keeping users engaged with the system is important and tends to result in the system generating more useful output information, as compared to usages of only sporadic user engagement with the system. It is assumed that more often that not, users will be motivated to use the system more if their interaction with the system is somehow rewarded in a recognizable way. It is assumed that such an engaged user will start to care about the user's relative reputation RP that is displayed to all users. Natural inclinations to compete come into play. Accordingly, the decay function D of the equation of FIG. 13 is provided to decrease the relative importance of aging reputation values and thereby to increase the relative importance of reputation values of the most recent computing cycle. Note that in the particular example of FIG. 13 a user's reputation value is only dependent upon the user's reputation value for the prior computing cycle, and the average of ERs in the current computing cycle for ROs of the user. Reputation values for earlier computing cycles are only taken into account to the extent that they had an impact on the D*RP_{T-1} historical reputation component of the equation. If a user disengages from using the system for a computing cycle, then the user's reputation will likely decrease, whereas continued engagement with the system from computing cycle to computing cycle will tend to keep the user's reputation at a higher level. This effect has a motivating influence on some users to stay engaged with the system.

Gaming:

The usefulness of the rating system is dependent upon the quality of ratings given, and the truthfulness of ratings is therefore important. For instance, what if the voter only gives an up rating because the user who submitted the RO is a friend? Or else gives down ratings to a single user or group of users in spite of the voter thinking that these users submitted good ROs. Or consider the situation in which groups of users form coalitions with each other and start voting “up” each others ROs, and voting “down” the ROs of targeted others. Such gaming allows untruthful votes to artificially prop up or beat down ROs irrespective of the true values of the ROs. The reputation of a user is directly dependent upon these factors and therefore untruthful ratings should not be used as is if possible. Untruthful ratings should be carefully weighed in the context of the rater and the RO. Gaming can only happen if the ratings are untruthful. Only when a rater thinks it is a good RO but still gives a down vote to malign the RO generator, is it gaming. Conversely, giving up votes to ROs generated by friends in spike of the voter really thinking the ROs are bad is also gaming.

An assumption is made that voting with the crowd correlates to truthful voting. This assumption stems from the fundamental belief that the crowd knows best and is a fundamental facet of crowd sourcing. This assumption is applied and used as a way to attempt to identify and to discount untruthful ratings. Bayes' theorem is applied in the equation of FIG. 10 to determine a probability P_{T} that the user who generated the AR acts with the crowd in generating actual ratings. If the user has a higher probability P_{T} of not voting with the crowd, then the likelihood of gaming and untruthful voting is higher. ARs from such a user should be discounted. Accordingly, the probability P_{T} is part of the weighting factor that is applied in the equation of FIG. 4 to convert an AR into a corresponding ER.

Although certain specific embodiments are described above for instructional purposes, the teachings of this patent document have general applicability and are not limited to the specific embodiments described above. Although a rating scale involving ratings of −1 and +1 is used in the specific embodiment set forth above, other rating scales can be used. Users may, for example, submit ratings on an integer scale of from one to ten. The rating system need not be a system for rating ideas, but rather may be a system for rating suppliers of products in an ecommerce application. The rating system may be a system for rating products such as in a consumer report type of application. Although specific equations are set forth above for how to calculate a user's reputation and for how to calculate an effective rating in one illustrative example, the novel general principles disclosed above regarding user reputations and effective ratings are not limited to these specific equations. Although in the specific embodiment set forth above a user is a person, the term user is not limited to a person but rather includes automatic agents. An example of an automatic agent is a computer program like a web crawler that generates ROs and submits the ROs to the rating system. Accordingly, various modifications, adaptations, and combinations of various features of the described embodiments can be practiced without departing from the scope of the invention as set forth in the claims.

1. A method comprising:
(a) storing rating information in a database, wherein the rating information includes for each of a plurality of actual ratings: an indication of a rated object for which the actual rating is a rating, an indication of which one of a plurality of users submitted the actual rating, an indication of which one of the plurality of users submitted the rated object, an effective rating corresponding to the actual rating, and a reputation value for the user who submitted the actual rating;
(b) receiving an actual rating for a first of the rated objects, wherein the first of the rated objects was submitted by a first user of the plurality of users, and wherein the actual rating was generated by a second user of the plurality of users;
(c) determining an effective rating corresponding to the actual rating of (b), wherein the effective rating is: 1) a function of a reputation value of the second user, and 2) a function of a probability that the second user acts with the crowd in generating actual ratings;
(d) determining an updated reputation value of the first user, wherein the determining of (d) is based at least in part on the effective rating determined in (c);
(e) including the updated reputation value of the first user determined in (d) as part of the rating information maintained in (a); and
(f) determining a ranking of the plurality of rated objects based at least in part on effective ratings stored in the database.

2. The method of claim 1, wherein (a) through (f) are performed by a rating system, and wherein the ranking of rated objects determined in (f) is displayed by the rating system.

3. The method of claim 1, wherein (a) through (f) are performed by a rating system, the method further comprising:
(g) determining a ranking of users based at least in part on reputation values stored in the database.

4. The method of claim 1, wherein the determining of (d) involves averaging a plurality of effective ratings, wherein the effective ratings that are averaged are effective ratings for one or more rated objects submitted by the first user.

5. The method of claim 1, wherein the determining of (d) involves multiplying the actual rating of (b) by a weighting factor, and wherein the weighting factor is a function of other effective ratings, and wherein the other effective ratings are ratings for rated objects submitted by the second user.

6. The method of claim 1, wherein the determining of (d) involves multiplying the actual rating of (b) by a weighting factor, and wherein the weighting factor is a function of a reputation value for the second user.

7. The method of claim 1, wherein the determining of (d) involves multiplying the actual rating of (b) by a weighting factor, and wherein the weighting factor is a function of a freshness of the actual rating.

8. The method of claim 1, wherein the determining of (d) involves multiplying the actual rating of (b) by a weighting factor, and wherein the weighting factor is a function of the probability that the second user acts with the crowd in generating actual ratings.

9. The method of claim 1, wherein the probability that the second user acts with the crowd in generating actual ratings is a probability given a general sentiment about the rated object.

10. The method of claim 1, wherein the rating information stored in (a) includes, for each user, a probability that the user acts with the crowd in generating actual ratings.

11. The method of claim 1, wherein the determining of the updated reputation value of (d) involves determining an average of effective ratings for rated objects submitted by the first user.

12. The method of claim 1, wherein the determining of the updated reputation value of (d) involves multiplying a prior reputation value for the first user by a decay value.

13. A method comprising:
(a) storing a database of rating information, wherein the rating information includes a reputation value for a user of a network-based rating system;
(b) receiving an actual rating onto the network-based rating system, wherein the actual rating is a rating of one of a plurality of rated objects;
(c) determining an effective rating based at least in part on the actual rating and the reputation value stored in the database;
(d) adding the effective rating into the database; and
(e) determining a ranking of the plurality of rated objects based at least in part on effective ratings stored in the database, wherein (a) through (e) are performed by the network-based rating system.

14. The method of claim 13, wherein the rating information stored in the database further includes a probability value, wherein the probability value indicates a probability that a user votes with the crowd when the voter submits actual ratings, and wherein the determining in (d) of the effective rating is also based on the probability value.

15. The method of claim 13, wherein the determining of (d) involves multiplying the actual rating by a weighting factor, wherein the weighting factor is a function of a probability that a user votes with the crowd when the voter submits actual ratings.

16. The method of claim 13, wherein the determining of (d) involves multiplying the actual rating by a weighting factor, wherein the weighting factor is a function of a freshness of the actual rating.

16. (canceled)

17. The method of claim 13, wherein the reputation value for the user was calculated by the network-based rating system based at least in part on an average of effective ratings.

18. The method of claim 13, wherein the reputation value for the user was calculated by the network-based rating system based at least in part on an average of effective ratings for rated objects submitted by the user.

19. The method of claim 13, wherein the reputation value for the user was calculated by the network-based rating system, and wherein the calculation of the reputation value involved multiplying a prior reputation value by a decay value.

20. The method of claim 13, wherein the network-based rating system determines a reputation value for each of a plurality of users, the method further comprising:
(f) determining a ranking of the users based at least in part on the reputation values for the plurality of users.

21. A network-based rating system comprising:
means for storing a database of rating information, wherein the rating information includes a plurality of effective ratings, wherein each effective rating corresponds to an actual rating, wherein each actual rating is a rating of one of a plurality of rated objects, wherein one of the rated objects was submitted by a first user, and wherein the rated information further includes a plurality of reputation values, wherein one of the reputation values is a reputation value for a second user;
means for determining an effective rating corresponding to an actual rating, wherein the actual rating was submitted by the second user for the rated object submitted by the first user, wherein the effective rating is: 1) a function of the actual rating submitted by the second user, and 2) a function of the reputation value for the second user; and
means for determining and displaying a ranking of the plurality of rated objects based at least in part on effective ratings stored in the database; and
means for determining and displaying a ranking of users based at least in part on reputation values stored in the database.

22. The network-based rating system of claim 21, wherein the means for storing is a portion of a server that stores database information, and wherein the means for determining an effective rating, the means for determining and displaying a ranking of rated objects, and the means for determining and displaying a ranking of users are parts of a rating system program executing on the server.

23. The method of claim 13, wherein the determining of (d) involves multiplying the actual rating by a weighting factor, and wherein the weighting factor is a function of the reputation value.
